(19) United States
(12) Patent Application Publication
(10) Pub. No.: US 2026/0174285 A1
(43) Pub. Date: Jun. 25, 2026

(54) CLOSING DEVICE FOR A GROUND MATERIAL CONTAINER, GROUND MATERIAL CONTAINER, AND COFFEE MACHINE COMPRISING SUCH A GROUND MATERIAL CONTAINER

(71) Applicant: NEXT LEVEL COFFEE GMBH, Konstanz (DE)

(72) Inventor: HENDRIKS Joris

(73) Assignee: NEXT LEVEL COFFEE GMBH, Konstanz (DE)

(21) Appl. No.: 19/124,662

(22) PCT Filed: Oct. 26, 2023
(86) PCT No.: PCT/EP2023/080023

§ 371 Date: Jul. 3, 2025

(30) Foreign Application Priority Data
Oct. 27, 2022 (DE) 10 2022 128 540.5

(51) Int. Cl. A47J 42/50; A23F 5/26; A47J 31/36; A47J 31/42

(52) U.S. Cl. CPC A47J 42/50; A23F 5/26; A47J 31/3614; A47J 31/42

(57) ABSTRACT

A closure device for a container for material to be ground includes a first closing element, a second closing element and an enclosure. A drive unit moves the second closing element relative to the enclosure and the first closing element. The first and second closing elements and the enclosure each include an opening for material to be ground. When all three openings overlap one another, material to be ground is discharged from the container. To close the container and to stop the flow of material to be ground, the second closing element is moved relative to the first closing element. After a predetermined distance travelled by the second closing element, the first closing element is carried along with the movement and the opening for material to be ground in the enclosure is closed to prevent clamped material to be ground from keeping the outlet opening open.

### CROSS-REFERENCE TO RELATED APPLICATIONS

This application is the U.S. National Phase of PCT/EP2023/080023 Filed Oct. 26, 2023, which claims Priority to DE 10 2022 128 540.5 Filed Oct. 27, 2022, the entire disclosures of which are incorporated by reference herein.

### TECHNICAL FIELD

The present disclosure relates to the use of containers for material to be ground for metering or dosing a quantity of material to be ground. In particular, the description relates to a controllable closing device for a container for material to be ground, a container for material to be ground with such a closing device, wherein the container for material to be ground is, for example, a coffee bean container, and a system consisting of a coffee machine and such a container for material to be ground

### BACKGROUND

Coffee drinks have been consumed for a long time. The general principle is basically always the same: a coffee bean is roasted, then the roasted coffee bean is ground to coffee powder, then a liquid, usually hot water, is applied to the coffee powder. In this last step, the liquid absorbs, among other things, flavorings from the coffee powder and can be consumed as a coffee drink.

There are different manual and machine possibilities for the preparation of coffee drinks. In particular, the machines for preparing coffee drinks enjoy great popularity.

Coffee machines can be constructed according to different principles. Usually, a coffee machine includes a reservoir for coffee powder. Hot water is then passed through the coffee powder and then collected in a drinking vessel.

The reservoir for coffee powder can be dimensioned such that it can receive coffee powder for one portion or a plurality of portions of the coffee drink. The coffee powder can either be introduced into the reservoir in the ground state or coffee beans are ground first and immediately before the brewing process, and the resulting coffee powder is then passed into the reservoir. The liquid is then either applied to the coffee powder under pressure or it flows through the coffee powder without pressure merely under the action of gravity. Other coffee machines are configured such that they can receive already pre-portioned coffee powder in a wide variety of containers and pass hot water through these containers.

A fundamental difference between the existing types of coffee machine is whether the roasted coffee beans are freshly ground before the brewing process or whether the coffee powder is already present in the ground state. For a high-quality coffee drink, it can be advantageous and desirable to grind the coffee beans only immediately before the brewing process, because the coffee powder can lose flavor and aromas in the case of long service lives.

It can now also be desirable to portion the coffee beans fed to a grinder, so that the weight of the resulting coffee powder is predetermined in this way. Furthermore, if a predetermined quantity of coffee beans is fed to the grinder, it can be avoided that residues of coffee beans remain in the grinder. Thus, after a grinding process, the type of coffee bean can be changed by placing another coffee bean container with another type of coffee bean on the grinder.

A coffee machine which makes this possible is described in the document WO 2022/167560 A1. This coffee machine makes it possible to dose the coffee beans by releasing an opening between the coffee bean container and the grinder for an adjustable time period, whereby the quantity of coffee beans for one portion of coffee drink is determined. After grinding, no coffee beans remain in the grinder and the coffee bean container can be changed in order to use another type of coffee beans for the next production process.

### SUMMARY

One or more objectives of the present disclosure is improving the precision when dosing material to be ground from a container for material to be ground.

As an example, it has been recognized that closable containers for material to be ground can clamp residues of material to be ground in a closing mechanism when closing the opening for the material to be ground, whereby a small opening remains, through which further material to be ground can pass into the grinder. As a result, the dosing becomes inaccurate. The present disclosure described herein is dedicated to this problem.

According to one aspect, a closing device for a container for material to be ground is provided. The closing device has a first closing element, a second closing element, an enclosure and a drive unit. The first closing element and the second closing element are arranged in the enclosure so as to be movable relative to one another. The drive unit is coupled to the second closing element to move the second closing element relative to the enclosure and relative to the first closing element. The enclosure has a first opening for material to be ground, the first closing element has a second opening for material to be ground, and the second closing element has a third opening for material to be ground. The first opening for material to be ground, the second opening for material to be ground and the third opening for material to be ground at least partially overlap one another in an outlet state and thus provide a through opening for material to be ground to flow through the through opening. In the outlet state, the second closing element is movable relative to the first closing element. The second closing element is engageable with the first closing element when the second closing element is moved relative to the first closing element. The second closing element is configured, when engaged with the first closing element, to move the first closing element therewith such that the second opening for material to be ground is displaced with respect to the first opening for material to be ground.

The closing device described here is preferably used together with a container for material to be ground and serves to selectively allow material to be ground located in an inner volume of the container for material to be ground to flow out or not. When the through opening is at least partially exposed (e.g., open), material to be ground flows out of an inner volume of the container for material to be ground through the through opening. Depending on how long the through opening is exposed, more or less material to be ground flows out of the container for material to be ground through the through opening. The quantity of the material to be ground that is exposed can thus be determined via the time period for which the through opening is open.

A controller controls the drive unit to move the first closing element and the second closing element into a corresponding position so that the through opening is exposed or closed. So that the quantity of the material to be ground that is exposed is predetermined precisely and repeatedly, it is necessary for the through opening to be moved into the closed state after the respectively predetermined time period has elapsed.

The closing device is mounted, for example, as a base of the container for material to be ground. When the openings for material to be ground of the enclosure, of the first closing element and of the second closing element overlap one another, they form a through opening through which the material to be ground can leave the inner volume of the container for material to be ground.

The closing device described here may be advantageously suitable for controlling a time period for material to be ground to flow out of the inner volume.

Thus, for example, the through opening can be exposed for a predetermined time period of a few seconds or tenths of a second and then closed again. This time period can be predetermined and maintained with a high degree of accuracy with the closing device described here, because the risk of material to be ground blocking the closing of the through opening is eliminated.

The state in which all three openings for material to be ground lie one above the other and a through opening is exposed can be referred to as the outlet state. The openings for material to be ground may have the same shape and dimension, so that in the outlet state, when they overlap one another, they provide a maximum size outlet opening for material to be ground.

In other words, this means that the closing device has two movable closing units which are movable relative to one another, whereby the through opening for the material to be ground that is exposed in the outlet state is closed in two stages. First, the second closing element is moved out of the passage position (outlet state, the three openings for material to be ground at least partially overlap one another, so that material to be ground can pass through the opening that is exposed in this way) in the direction of a blocking position. The closing elements are movable to such an extent that their respective opening for material to be ground in the blocking position is positioned completely next to the opening for material to be ground of the enclosure, so that material to be ground can no longer flow out of the inner volume of the container for material to be ground. After the second closing element has been moved a certain distance in the direction of the blocking position, the second closing element engages in the first closing element and also moves the first closing element out of the passage position in the direction of the blocking position.

The state in which the second closing element engages in the first closing element and begins to carry along the first closing element in its movement is referred to as the intermediate state. The intermediate state can be achieved in two ways: with or without material to be ground which is clamped between the second opening for material to be ground and the third opening for material to be ground (or, in other words, between the first closing element and the second closing element at their respective openings for material to be ground). In both cases, however, the same happens when the second closing element is moved further in the direction of the blocking position.

In the intermediate state and when no material to be ground is clamped between the first and second closing elements, the third opening for material to be ground has already been moved to such an extent that it no longer overlaps the second opening for material to be ground. This means that in the intermediate state there is also no longer a through opening and the material to be ground has stopped flowing out of the inner volume of the container for material to be ground. If, on the other hand, material to be ground is clamped between the first and second closing elements, the second closing element carries along the first closing element in that the force is transmitted to the first closing element via the clamped material to be ground.

This construction has the advantage that material to be ground which is clamped, if appropriate, between the second closing element and the first closing element during the movement of the second closing element is prevented from falling out of the container for material to be ground and furthermore it is prevented that further material to be ground falls through the remaining opening between the first closing element and the second closing element. The clamped material to be ground ensures that the second closing element carries along the first closing element because the second closing element exerts a force on the first closing element via the clamped material to be ground and thereby moves the first closing element with respect to the enclosure and the first opening for material to be ground in the enclosure. Even if the material to be ground which was previously clamped between the first and second closing elements is now exposed again, this material to be ground does not fall out of the container for material to be ground because the second opening for material to be ground of the first closing element is displaced with respect to the first opening for material to be ground of the enclosure. And if further material to be ground falls through the remaining opening between the first closing element and the second closing element, this material to be ground no longer falls into the grinder because the second opening for material to be ground of the first closing element is no longer in overlap with the first opening for material to be ground of the enclosure.

According to one embodiment, the first opening for material to be ground is completely overlapped by both the second opening for material to be ground and the third opening for material to be ground in the outlet state to provide the through opening.

In this way, the through opening has a maximum possible cross section because an opening for material to be ground in one of the components is not concealed by another component, but the openings for material to be ground as such overlap.

According to a further embodiment, the first opening for material to be ground, the second opening for material to be ground and the third opening for material to be ground have an identical size and shape.

When the identically shaped and equally sized openings for material to be ground completely overlap one another in the outlet state and are not displaced relative to one another, no intermediate stages on which material to be ground can remain are formed in the through opening.

According to a further embodiment, a movement clearance of the second closing element is greater than a movement clearance of the first closing element.

When the second closing element is moved out of the outlet state in the direction of the blocking state, only the second closing element moves at a first stage. The first closing element is carried along with the second closing element as soon as the closing elements are in engagement with one another (due to clamped material to be ground or because the second closing element engages in the first closing element via a driver). To be able to move the first closing element to such an extent that the second opening for material to be ground no longer overlaps the first opening for material to be ground in the enclosure and closes the container for material to be ground, the second closing element has to cover a correspondingly greater movement distance. The second closing element thus first moves alone at the beginning of the movement, then engages in the first closing element and carries along the first closing element until the second opening for material to be ground in the first closing element lies completely next to the first opening for material to be ground in the enclosure.

For example, the second closing element first moves with respect to the first closing element to such an extent that the third opening for material to be ground and the second opening for material to be ground no longer overlap one another (unless material to be ground is clamped between the first and second closing elements). The second closing element then engages in the first closing element and carries along the first closing element in the same direction. The second opening for material to be ground is now also displaced with respect to the first opening for material to be ground.

This two-stage approach to close the through opening of the container for material to be ground contributes to being able to portion the material to be ground particularly well, for example by predetermining the time period for which material to be ground is discharged from the container for material to be ground. A controller controls the drive unit to move the closing elements according to the scheme described here.

When, for example, material to be ground is clamped between the first closing element and the second closing element when the second closing element is moved into the blocking state, a small opening is still exposed through which material to be ground can flow out. In order to avoid precisely this, the first closing element is carried along by the second closing element when material to be ground is clamped in between. When material to be ground is clamped between the second closing element and the first closing element, these two closing elements are in engagement with one another. If, on the other hand, no material to be ground is clamped between the second closing element and the first closing element, a driving mechanism described further below ensures that the first closing element is carried along by the second closing element in the direction of the blocking state.

During a rotational movement of the closing elements, for example, the second closing element is configured such that it can perform a rotational movement through 180° about the axis of rotation in the enclosure, which can also be the drive axis of the drive unit at the same time. The first closing element can perform a rotational movement through 90° about the same axis of rotation.

In the outlet state, the openings for material to be ground of the enclosure, of the first closing element and of the second closing element overlap and expose a through opening. If the through opening is now to be closed, the second closing element is first moved in the direction of the blocking state until it comes into engagement with the first closing element. This is either the case when material to be ground is clamped between the first and second closing elements or when a driving mechanism carries along the first closing element. For example, when no material to be ground is clamped, the second closing element rotates through 90°, then a driver or a gripping nose of the second closing element bears against a driving surface of the first closing element and carries along the first closing element during its movement through a further 90°. In this state, no opening for material to be ground overlaps the other opening.

According to a further embodiment, the second closing element has a driver and the first closing element has an engagement. The driver is configured to be moved in the engagement with a predetermined movement clearance. The driver is configured to entrain the first closing element during a movement of the second closing element when the driver strikes an edge of the engagement during the movement of the second closing element.

In this example, a mechanical driving mechanism is described. The engagement is configured, for example, as a recess or longitudinal groove. The driver can move in the engagement in a predetermined range. However, if the second closing element is moved to such an extent that the driver strikes an edge of the engagement, the driver carries along the first closing element. However, if material to be ground is clamped between the first and the second closing element, the first closing element is carried along, even without the driver striking the edge of the engagement.

This construction makes it possible in any case that the through opening out of the inner volume of the container for material to be ground is closed, irrespective of whether material to be ground is clamped between the first and the second closing elements.

According to a further embodiment, the first closing element and the second closing element are configured to perform a rotational movement with respect to the enclosure.

In this example, the first closing element and the second closing element are rotatably mounted in the enclosure. The drive unit is coupled to the second closing element via a shaft and/or a gear mechanism. The drive unit can be, for example, an electric motor, stepping motor or servomotor. However, the drive unit can also have more than one single motor. The drive unit exerts a force on the second closing element by means of the electric motor and the shaft and/or the gear mechanism and sets the second closing element in motion. During this movement, the third opening for material to be ground moves out of the passage position into the blocking position, i.e., the third opening for material to be ground of the second closing element is moved out of a state in which it overlaps the second opening for material to be ground of the first closing element into a state in which these openings no longer overlap one another, whereby material to be ground can no longer escape from the inner volume of the container for material to be ground.

As an alternative to the rotational movement described here, it is also possible for the first closing element and the second closing element to perform a translational or linear movement with respect to one another. Even with a linear movement, the second closing element can be moved with respect to the first closing element such that openings for material to be ground respectively located therein overlap or do not overlap one another. In the case of a linear movement, a corresponding drive unit is used which performs a linear movement instead of a rotational movement.

According to a further embodiment, the second closing element is funnel-shaped in order to guide material to be ground in the direction of the third opening for material to be ground.

The bottom surface of the second closing element is inclined in a funnel-shaped manner so that the material to be ground located in the inner volume of the container for material to be ground is guided to the third opening for material to be ground and no residues of material to be ground remain in the container for material to be ground.

According to a further aspect, a container for material to be ground is provided. The container for material to be ground has a housing, an inner volume defined by the housing for receiving material to be ground, and a closing device as described herein.

The housing can be configured, for example, in a cup-shaped or pot-shaped manner, i.e. substantially have the shape of a cylinder. The closing device is attached to an end face of the housing. The closing device serves to allow material to be ground located in the inner volume to flow out of the container for material to be ground or to block it.

Such a container for material to be ground is advantageously used where material to be ground has to be dosed precisely. For example, such a container for material to be ground can be used in conjunction with a coffee bean mill in order to dose the quantity of the coffee beans put into a grinder by predetermining the time period in which coffee beans can flow out of the container for material to be ground and closing the through opening of the closing device after the predetermined time period.

The closing device is arranged on that end face of the container for material to be ground which, in the state in which the container for material to be ground is coupled to the coffee machine or the coffee bean mill, is arranged between the inner volume of the container for material to be ground and the grinder. In other words, the closing device represents the underside of the container for material to be ground when the container for material to be ground is inserted in the coffee machine or the coffee bean mill.

However, the container for material to be ground is not restricted to being used with coffee beans and coffee mills. Rather, this container for material to be ground can be used for all material to be ground which has to be dosed precisely, such as via a time control.

According to a further embodiment, the container for material to be ground is a coffee bean container for use with a coffee machine.

The coffee bean container can be, for example, an exchangeable coffee bean container. Such a coffee bean container is coupled to a coffee mill and makes it possible for a defined amount of coffee beans to be dispensed from the coffee bean container into the coffee mill in order to produce a coffee drink. The closure device described herein makes it possible for the coffee beans dispensed into the coffee mill to be dosed precisely. As an example, the amount of the dispensed coffee beans is dosed such that it is adapted for a coffee drink. The coffee mill or the grinder thereof grinds the entire amount of coffee beans dispensed and is empty after the grinding process. The ground coffee beans can now be used for producing a coffee drink. The amount of the coffee beans is set via the time period during which the closing device exposes the through opening. Since the entire material to be ground is ground by the grinder, no unground coffee beans remain in the grinder. Thus, after a grinding process, the container for material to be ground can be removed and another container for material to be ground with another type of coffee bean can be inserted. This makes it possible for different types of coffee beans to be ground with the same coffee mill.

A coffee machine which produces or can produce coffee drinks in this way is described, for example, in WO 2022/167560 A1.

For example, the coffee bean container has a housing, an outlet and an identification element. The housing is configured to receive coffee beans. The outlet is arranged to discharge coffee beans from the housing and is provided with a closing device as described herein in order to selectively open or close the outlet. The identification element can be read by machine and includes an instruction for setting parameters of a coffee machine for the preparation of a coffee drink with the coffee beans from the housing. Data of the identification element are read by the controller and the coffee machine can then be correspondingly parameterized. The identification element can be read optically or electromagnetically. The coffee bean container thus contains a specification for the setting of the coffee machine and/or the coffee mill in order to produce a coffee drink with the contained coffee beans.

The identification element can be a character sequence which functions as an identification and makes it possible for the coffee machine to carry out the setting parameters assigned to this character sequence. Alternatively, the identification element can contain the setting parameters.

According to a further aspect, a system consisting of a coffee machine and a container for material to be ground as described herein is provided. The coffee machine is configured to dose an amount of coffee beans dispensed from the container for material to be ground by specifying a time period during which the closure device of the container for material to be ground is in an outlet state.

The system makes it possible for the coffee machine to be used for the fresh preparation of coffee drinks on the basis of freshly ground coffee beans with a plurality of different coffee bean containers (and different coffee beans or types of coffee beans located therein), wherein the coffee bean containers can be selectively inserted and the coffee machine parameterizes itself on the identification element of the coffee bean container depending on the parameterization specifications.

In general, it is conceivable in conjunction with the coffee machine and the system that a user of the coffee machine deviates from the predetermined parameters for the setting of the coffee machine. Although the coffee machine sets these parameters, a user can permanently or temporarily change the predetermined parameters for a particular type of coffee and thus, for example, teach (parameterize) a new type of coffee bean. For this purpose, the coffee machine can contain a data memory which stores the user-specific parameterization for a particular identifier of a coffee bean container. If the coffee machine reads this identifier from the identification element, the parameters from the data memory can then be applied directly. For this purpose, this data memory can optionally be arranged in a decentralized manner, wherein in this case the data memory is accessible via a data network. Such a central data memory can be updated from a central point, for example by virtue of the parameters being adapted centrally for a particular type of coffee bean, for example by virtue of existing parameters being changed for a type of coffee bean or a set of parameters being offered for a new type of coffee bean. The central data memory can be contacted and read during each adaptation of the coffee machine parameters in order to apply the read parameters in a decentralized manner to the respective coffee machine or the data memory can serve as a source for the distribution of updated parameters to the coffee machines, so that the parameters are held in a decentralized manner in the coffee machines after the updating operation.

The container for material to be ground serves as a coffee bean container. With the closing device, a portion of coffee beans for producing a coffee drink can be introduced into the coffee bean mill in a precisely dosed manner. The coffee bean mill grinds all the coffee beans introduced. If a user of the coffee machine wishes to produce a further coffee drink on the basis of another type of coffee bean following a production process of a coffee drink, the container for material to be ground can be changed. The coffee beans of the other type of coffee bean can now be used for producing the further coffee drink, since these coffee beans are not mixed with the initially ground type of coffee bean.

If the container for material to be ground is changed, the time period during which the closing device is in the outlet state can also be adapted. Thus, coffee beans of different types of coffee bean can be dosed with an individual recipe for producing a coffee drink. Containers for material to be ground can be recognized automatically, as described in WO 2022/167560 A1. Depending on the recognized containers for material to be ground, the controller can specify a different time period during which the drive unit allows coffee beans to flow into the grinder in order to dose the coffee beans as desired.

In the case of a coffee machine with a grinder, which freshly grinds the coffee powder for one portion of coffee as required, it is generally not possible and also not customary to change the coffee beans as long as beans are still located in a bean container. The change to another type of coffee bean is thus restricted to the point in time when the bean container and the grinder have been emptied. In the present case, this is avoided in that only as many coffee beans are discharged from the coffee bean container into the receiving volume of the grinder as are necessary for the preparation of one portion of coffee. The coffee bean container is then closed by the closing device and no further beans fall into the grinder. The coffee bean container can be detached from the coffee bean container receiving device, in the process the outlet opening of the coffee bean container is closed, and another coffee bean container with another type of coffee bean can be used. After another coffee bean container has been inserted into the coffee bean container receiving device, the time period for dosing the amounts of the dispensed coffee beans can be changed in order to use the appropriate amount of the coffee beans for the desired coffee taste or taking into account the properties of the coffee beans.

### BRIEF DESCRIPTION OF THE DRAWINGS

Exemplary embodiments will be discussed in more detail below with reference to the appended drawings. The illustrations are schematic and not true to scale. Identical reference signs relate to identical or similar elements. In the figures it is shown in:

FIG. 1 a schematic illustration of a system for preparing coffee drinks with a coffee machine and a container for material to be ground with a closing device.

FIG. 2 a schematic illustration of a closing device.

FIG. 3 a schematic illustration of components of a closing device.

FIG. 4 a schematic illustration of an enclosure of a closing device.

FIG. 5 a schematic illustration of an enclosure with mounted first closing element of a closing device.

FIG. 6 a schematic illustration of an enclosure with mounted first and second closing element of a closing device.

FIG. 7 a schematic illustration of a first and second closing element of a closing device.

FIG. 8 a schematic illustration of an enclosure with first closing element of a closing device in the blocking state.

FIG. 9 a schematic illustration of an enclosure with first closing element of a closing device in the outlet state.

FIG. 10 a schematic illustration of an enclosure with first and second closing element of a closing device in the blocking state.

FIG. 11 a schematic illustration of an enclosure with first and second closing element of a closing device in the outlet state.

FIG. 12 a schematic illustration of an enclosure with first and second closing element of a closing device in the intermediate state.

FIG. 13 a schematic illustration of an enclosure with first and second closing element of a closing device, in which the second closing element is on its way into the blocking state.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

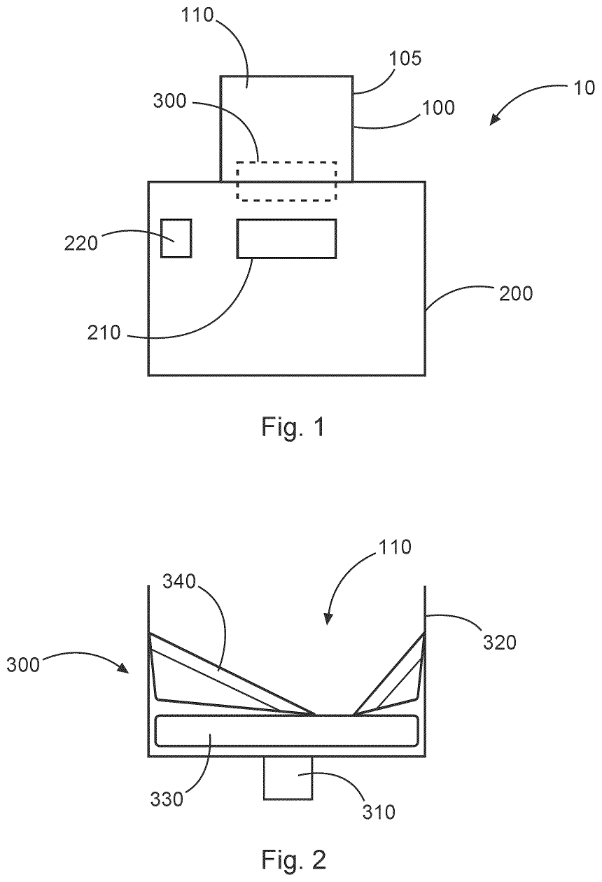

FIG. 1 shows a system 10 consisting of a coffee machine 200 and a container 100 for material to be ground. The container 100 for material to be ground includes a housing 105 which encloses an internal volume 110. The container 100 for material to be ground is closed with a closing device 300 and, in the example of FIG. 1, is coupled to the coffee machine 200. The coffee machine 200 is shown here by way of example with some of its components. Thus, the coffee machine 200 comprises a grinder 210 and a controller 220. The controller 220 is configured to control the grinder 210 and other components of the coffee machine 200.

Coffee beans are stored in the container 100 for material to be ground. When a coffee drink is to be produced, coffee beans are dispensed from the inner volume 110 of the container 100 for material to be ground to the grinder 210. For this purpose, the controller 220 controls the closing device 300 to dispense coffee beans from the inner volume 110. The controller 220 is configured to move the closing device 300 into an open state (outlet state) for a predetermined time period and to move the closing device 300 into a closed state (blocking state) when this predetermined time period has elapsed.

The grinder 210 grinds the coffee beans and thus provides a powder which is used for the preparation of a coffee drink. The controller 220 can also be configured to control the running time of the grinder 210. As an example, the grinder 210 preferably grinds until all the coffee beans dispensed from the inner volume 110 of the container 100 for material to be ground have been ground. Thus, no significant residues of coffee beans remain in the grinder 210 and another container 100 for material to be ground with another type of coffee bean can be placed for the preparation of the next coffee drink.

FIG. 2 shows a schematic view of a closing device 300 and its components. The closing device 300 comprises a drive unit 310, an enclosure 320, a first closing element 330 and a second closing element 340.

The drive unit 310 can be structurally assigned to the closing device, but the drive unit 310 can also be a component of the coffee machine 200. When the container 100 for material to be ground is placed on the coffee machine 200, a force transmission element (a shaft, for example) of the drive unit is connected to the closing device 300 in order to apply a drive force to the first closing element 330 and the second closing element 340.

As can be derived from this illustration, the second closing element 340 is shaped like a funnel whose oblique inner surfaces guide the material to be ground in the inner volume 110 to the corresponding opening for the material to be ground.

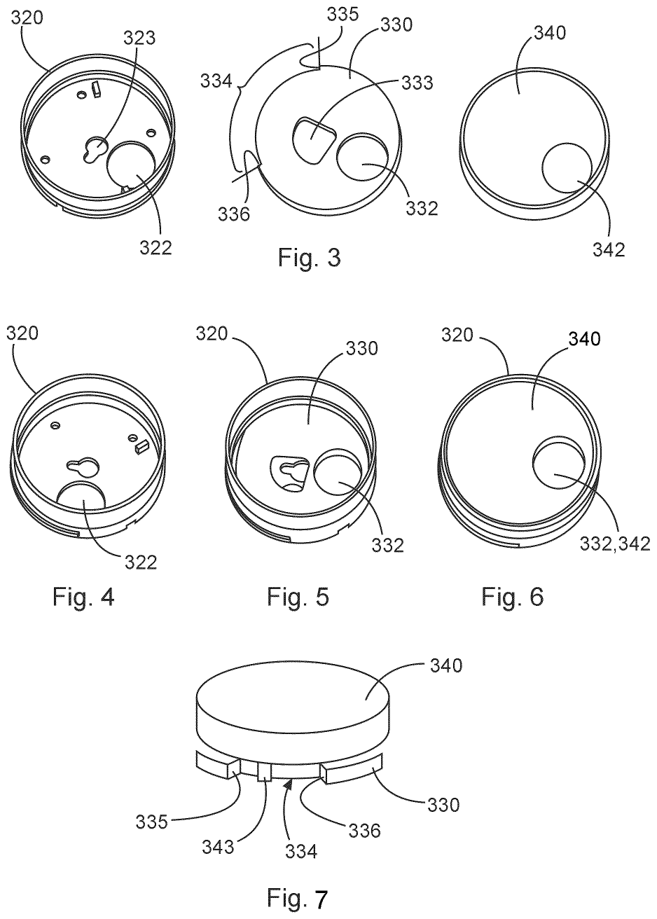

FIG. 3 shows an enclosure 320, a first closing element 330 and a second closing element 340 of a closing device as described herein.

In this example, the enclosure 320 has a circular cross section and serves to receive the first closing element and the second closing element. The enclosure 320 has a drive opening 323 through which a drive shaft of the drive unit is guided. Furthermore, the enclosure 320 has a first opening 322 for material to be ground through which the material to be ground falls out of the inner volume of the container for material to be ground into the grinder of the coffee machine.

The first closing element 330 likewise has a drive opening 333 through which the drive shaft of the drive unit is guided. Furthermore, the first closing element 330 has the second opening 332 for material to be ground through which the material to be ground falls out of the inner volume of the container for material to be ground. In an edge region, the first closing element 330 has an engagement or a recess 334 in the form of a radial depression. This engagement 334 extends approximately over a quarter of the circumference of the first closing element 330. The engagement 334 is delimited by a first edge 335 and a second edge 336. The first edge 335 and the second edge 336 are located at the point at which the radius of the first closing element 330 rises abruptly. The engagement 334 makes it possible for the first closing element 330 to be carried along by the second closing element 340, but nevertheless makes it possible for the second closing element to have play for a movement relative to the first closing element.

FIGS. 4 to 6 show how the first closing element 330 and the second closing element 340 are mounted in the enclosure 320. FIG. 4 shows the enclosure 320 alone with the first opening 322 for material to be ground, as already shown in FIG. 3.

FIG. 5 shows the enclosure 320 with the mounted first closing element 330. It can be seen that the drive openings 323, 333 (see FIG. 3) lie one above the other, and therefore a drive shaft can be guided from the drive unit to the second closing element through these drive openings. Apart from that, in the illustration of FIG. 5, the second opening 332 for material to be ground is displaced relative to the first opening 322 for material to be ground. In this state, no material to be ground can fall out of the inner volume of the container for material to be ground through the second opening 332 for material to be ground. In principle, the first closing element 330 is rotatably mounted in the enclosure 320 and allows a rotational movement through at least approximately 90°. With the aid of stop elements on the first closing element or on the enclosure, the range of the rotational movement of the first closing element 330 in one direction or in both directions can be delimited. It is decisive that the first closing element 330 can be moved into an outlet state in which the second opening 332 for material to be ground overlaps the first opening 322 for material to be ground, and that the first closing element 330 can be moved into a second state in which the second opening 332 for material to be ground does not overlap the first opening 322 for material to be ground, i.e. is displaced with respect thereto.

FIG. 6 now shows the next state in which the second closing element 340 is mounted on the first closing element 330 and in the enclosure 320. In the state shown, the third opening 342 for material to be ground overlaps the second opening 332 for material to be ground, but the two openings 342, 332 are displaced with respect to the first opening 322 for material to be ground such that no material to be ground can escape from the inner volume of the container for material to be ground.

As can be seen without difficulty from the illustration of FIGS. 4 to 6, the first closing element 330 can be moved together with the second closing element 340 out of the state of FIG. 6 in the clockwise direction until the openings 332, 342 for material to be ground overlap the first opening 322 for material to be ground. The state then achieved is described as the outlet state. In this state, coffee beans fall out of the inner volume of the container for material to be ground into the grinder. The coffee beans are portioned or dosed by first moving the second closing element 340 in the counterclockwise direction in order to interrupt the flow of the coffee beans.

First, only the second closing element 340 is rotated in the counterclockwise direction. When a coffee bean is clamped between the second closing element 340 and the first closing element 330 in the third opening 342 for material to be ground and the second opening 332 for material to be ground, the rotating second closing element 340 carries along the first closing element 330 because the first closing element 330 can rotate within predetermined limits in the enclosure 320. If, on the other hand, no coffee bean is clamped between the second closing element 340 and the first closing element 330, the second closing element 340 carries along the first closing element 330 with a driving mechanism and moves the second opening 332 for material to be ground away from the first opening 322 for material to be ground.

This driving mechanism is described with reference to FIG. 7. The first closing element 330 and the second closing element 340 are shown here schematically from the side. The first closing element 330 is provided with the engagement 334, which was also shown and described with reference to FIG. 3. The engagement 334 is delimited by the first edge 335 and the second edge 336. In this engagement 334 configured as a radial depression, a driver 343 or a gripping nose can move when the second closing element 340 is set in rotation. As long as the driver 343 moves between the first edge 335 and the second edge 336, the movement of the second closing element 340 is not transferred to the first closing element 330. However, if the second closing element 340 rotates in the counterclockwise direction and the driver 343 comes up against the second edge 336, then the second closing element 340 carries along the first closing element during the further movement in the clockwise direction. During this movement, the second opening 332 for material to be ground is guided away from the first opening 322 for material to be ground.

Depending on the state of the closing device 300, the second opening 332 for material to be ground and the third opening 342 for material to be ground are located at different positions with respect to the first opening 322 for material to be ground and also the driver 343 is located in the engagement 334 at a corresponding position.

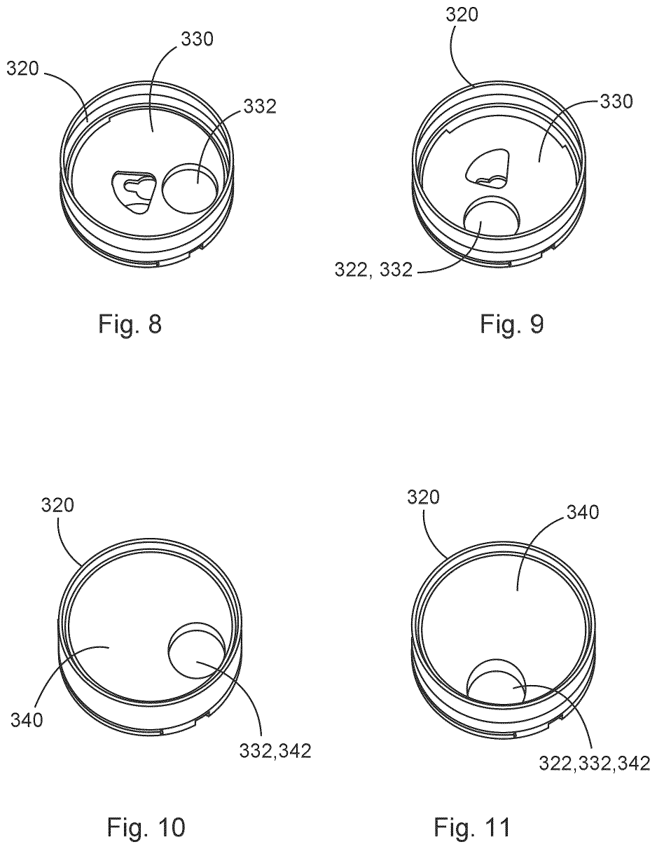

FIG. 8 shows the first closing element 330 in the blocked state, in which the second opening 332 for material to be ground is displaced with respect to the first opening 322 for material to be ground, so that no coffee beans can fall out of the inner volume of the container for material to be ground into the grinder.

FIG. 9 shows the first closing element 330 in the outlet state, in which the second opening 332 for material to be ground overlaps the first opening 322 for material to be ground, so that coffee beans can fall out of the inner volume of the container for material to be ground into the grinder.

The first closing element 330 can assume the two positions shown in FIGS. 8 and 9 and all intermediate states between these two positions, wherein the possible intermediate states between these two positions are assumed when the first closing element 330 moves from the position of FIG. 8 in the clockwise direction into the position of FIG. 9 or from the position of FIG. 9 in the counterclockwise direction into the position of FIG. 8. Thus, in this example, the first closing element 330 moves by approximately 90° in the clockwise or counterclockwise direction.

FIGS. 10 to 12 show the different states which the second closing element 340 together with the first closing element 330 can assume in the enclosure 320.

In the state of FIG. 10, the third opening 342 for material to be ground overlaps the second opening 332 for material to be ground, wherein the openings 332, 342 are displaced with respect to the first opening 322 for material to be ground. In this state, no coffee beans can fall into the grinder. With reference to FIG. 7, it should be noted that the driver 343 is located at the first edge 335 in the state of FIG. 10.

When a command comes from the controller to dispense a portion of coffee beans into the grinder, the drive unit drives the second closing element 340 so that it moves in the clockwise direction until the third opening 342 for material to be ground and the second opening 332 for material to be ground overlap the first opening 322 for material to be ground and thus release an opening through which coffee beans can fall out of the inner volume into the grinder. During this movement of the second closing element 340, the driver 343 carries along the first closing element 330 because the driver 343 bears against the edge 335.

The closing device remains in the state of FIG. 11 for a predetermined time period. This time period is the parameter by which the amount of the coffee beans dispensed into the grinder is dosed. When this time period has elapsed, the controller outputs a command to the drive unit so that the closing device is moved into the blocking state. For this purpose, the second closing element 340 is moved in the counterclockwise direction starting from the state of FIG. 11. During this movement, the driver 343 moves in the engagement 334 from the first edge 335 in the direction of the second edge 336. If a coffee bean is clamped between the first closing element and the second closing element before the driver 334 reaches the second edge 336, then the second closing element carries along the first closing element during its movement in the counterclockwise direction via the clamped coffee bean. Otherwise, the second closing element carries along the first closing element from its movement in the counterclockwise direction with the driver 343, which bears against the second edge 336.

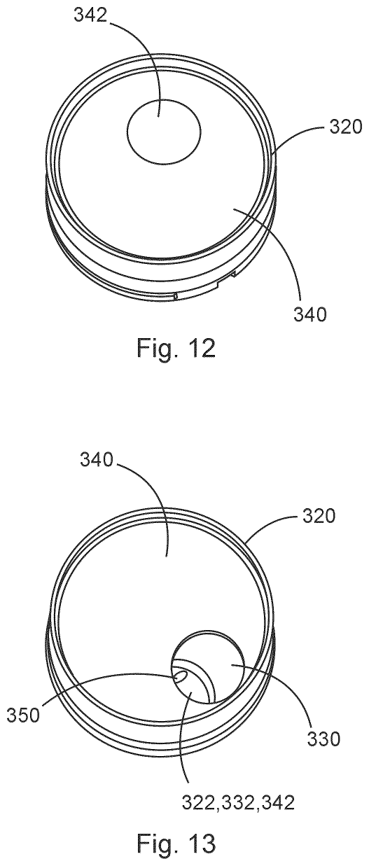

From the position shown in FIG. 11, the second closing element 340 first moves by 90° in the counterclockwise direction, then the driver 343 carries along the first closing element 330 by a further 90° in the counterclockwise direction. Thus, the second closing element 340 has rotated overall by 180° and the first closing element 330 by 90° in the counterclockwise direction. This state is shown in FIG. 12.

In order to now return to the state of FIG. 10 starting from the state of FIG. 12, the second closing element 340 is rotated in the clockwise direction until the third opening 342 for material to be ground overlaps the second opening 332 for material to be ground. In the controller, the values for the relative distance between the openings for material to be ground are stored so that the corresponding positions can be approached by the controller with the aid of the drive unit.

FIG. 13 shows by way of example the state when the second closing element 340 is moved out of the outlet state (FIG. 11) in the direction of the blocking state (FIG. 12). The second closing element 340 has been moved in the counterclockwise direction in the enclosure 320 to such an extent that the third opening 342 for material to be ground only partially overlaps the other two openings 332, 322 for material to be ground. However, a coffee bean 350 is clamped in the opening 342 for material to be ground between the second closing element 340 and the first closing element 330. If the second closing element 340 is now rotated further in the counterclockwise direction, then the first closing element 330 can be carried along during this movement via the clamped coffee bean 350. The coffee bean 350 functions as it were a driver, as described with reference to FIG. 7. In this way, it is reliably avoided that coffee beans continue to fall out of the inner volume into the grinder. Coffee beans can be clamped at most between the second closing element and the first closing element. When this happens, the second opening for material to be ground initially still completely overlaps the first opening for material to be ground. The first closing element now begins to move together with the second closing element, but the overlap between the first opening for material to be ground and the second opening for material to be ground is still sufficiently large so that coffee beans possibly located at this height are not clamped between the first closing element and the enclosure. Until the movement of the second closing element 340 has carried along the first closing element 330 to such an extent that the second opening for material to be ground is displaced with respect to the first opening for material to be ground, all coffee beans located at this height have fallen into the grinder.

In this way, the amount of the coffee beans dispensed from the container for material to be ground into the grinder can be dosed precisely and the closing device can be closed reliably. The risk of a clamped coffee bean preventing or impeding the closing of the closing device is eliminated in this way.

The edges which enclose the openings 322, 332, 342 for material to be ground can be rounded. This means that the edges of the openings which clamp the coffee bean 350 in the illustration of FIG. 13 do not have a planar end face with sharp edges, but rather have rounded edges in a direction which corresponds to the flow direction of the material to be ground through the openings for material to be ground. The material to be ground can thus, if a low clamping force or a slight pressure acts thereon, be pressed more easily upwards back into the inner volume of the container for material to be ground or downwards out of the opening for material to be ground by means of the rounded edges.

Even if a closing device 300 with rotatably mounted closing elements is shown in FIGS. 3 to 13, it is also conceivable for the second closing element to be moved linearly with respect to the first closing element in order to bring the corresponding openings for material to be ground into overlap or to displace them with respect to one another.

In the description of the states and the movement of the components between the individual states of the closing device, reference was made to movement directions in the clockwise direction and in the counterclockwise direction. It goes without saying that it is possible, while retaining the function of the closing device, to implement all these movement directions also in the opposite direction (“mirror-inverted”). In this respect, the movement directions selected for the description of the figures are to be understood merely by way of example.

In addition, it should be pointed out that “including” or “comprising” does not exclude any other elements or steps and “a” or “an” does not exclude a plurality. Furthermore, it should be pointed out that features or steps which have been described with reference to one of the above exemplary embodiments can also be used in combination with other features or steps of other exemplary embodiments described above. Reference signs in the claims are not to be regarded as a restriction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

10 system
100 container for a material to be ground, coffee bean container
105 housing
110 internal volume
200 coffee machine
210 grinder
220 controller
300 closing device
310 drive unit
320 enclosure
322 first opening for material to be ground
323 drive opening
330 first closing element
332 second opening for material to be ground
333 drive opening
334 engagement, recess, radial groove
335 edge
336 edge
340 second closing element
342 third opening for material to be ground
343 driver, gripping nose
350 coffee bean

1. A closing device for a container for material to be ground, the closing device comprising:
a first closing element;
a second closing element;
an enclosure; and
a drive unit;
wherein the first closing element and the second closing element are arranged in the enclosure so as to be movable relative to one another;
wherein the drive unit is coupled to the second closing element to move the second closing element relative to the enclosure and relative to the first closing element;
wherein the enclosure has a first opening for the material to be ground, the first closing element has a second opening for material to be ground, and the second closing element has a third opening for material to be ground;
wherein the first opening, the second opening and the third opening at least partially overlap one another in an outlet state and thus provide a through opening for the material to be ground to flow through the through opening;
wherein, in the outlet state, the second closing element is movable relative to the first closing element;
wherein the second closing element is engageable with the first closing element when the second closing element is moved relative to the first closing element; and
wherein the second closing element is configured, when engaged with the first closing element, to move the first closing element therewith such that the second opening is displaced with respect to the first opening.

2. The closing device of claim 1,
wherein the first opening is completely overlapped by both the second opening and the third opening in the outlet state to form the through opening.

3. The closing device of claim 2,
wherein the first opening, the second opening and the third opening have an identical size and shape.

4. The closing device of claim 1,
wherein a movement clearance of the second closing element is greater than a movement clearance of the first closing element.

5. The closing device of claim 1,
wherein the second closing element has a driver;
wherein the first closing element has a recess;
wherein the driver is configured to be moved in the recess with a predetermined movement clearance;
wherein the driver is configured to entrain the first closing element during a movement of the second closing element when the driver strikes an edge of the recess during the movement of the second closing element.

6. The closing device of claim 1,
wherein the first closing element and the second closing element are configured to perform a rotational movement with respect to the enclosure.

7. The closing device of claim 1,
wherein the second closing element is funnel-shaped in order to guide the material to be ground in the direction of the third opening.

8. A container for material to be ground, the container comprising:
a housing defining;
an internal volume for receiving the material to be ground; and
the closing device of claim 1.

9. The container of claim 8,
wherein the container is a coffee bean container for use with a coffee machine.

10. A system, comprising:
a coffee machine; and
the container for material to be ground of claim 9;
wherein the coffee machine is configured to dose an amount of coffee beans dispensed from the container for material to be ground by specifying a time period during which the closure device of the container for material to be ground is in an outlet state.
